(19) United States
(12) Patent Application Publication
(10) Pub. No.: US 2007/0233819 A1
(43) Pub. Date: Oct. 4, 2007

(54) Content playing system, playing apparatus, streaming play method and computer-readable recording medium

(75) Inventor: Makoto Sato, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Kabushikikaisha Kenwood, Tokyo (JP)

(21) Appl. No.: 11/731,200

(22) Filed: Mar. 29, 2007

(30) Foreign Application Priority Data
Mar. 29, 2006 (JP) 2006-092335

(51) Int. Cl. G06F 15/16

(52) U.S. Cl. 709/219

(57) ABSTRACT

A content, which is streaming-distributed, is easily resume-played. A content server stores content data which can be streaming-played. A first playing apparatus now performing streaming play determines whether or not a second playing apparatus, which the first playing apparatus means to perform resume playing, is turned on, and controls the second playing apparatus to be turned on if not turned on. The first playing apparatus now performing streaming play stops playing, and sends a resumption start position to the second playing apparatus. The second playing apparatus meant to perform resume playing resume-plays the content data from the received resumption start position.

### CROSS-REFERENCES TO RELATED APPLICATIONS

This application claims priority to Japanese Patent Application No. 2006-092335, filed on Mar. 29, 2006 and including specification, claims, drawings and summary. The disclosure of the above Japanese Patent Application is incorporated herein by reference in its entirety.

### BACKGROUND OF THE INVENTION

1. Field of the Invention

The present invention relates to a content playing system, a playing apparatus, a streaming play method, and a program suitable for easily resuming playing content, which is streaming-distributed.

2. Description of the Related Art

Various software contents having a large data size such as moving images, music, etc. are distributed through the Internet with the use of streaming play techniques. Users play data while receiving data, using application software such as browsers, etc., which can streaming-play data. For example, Unexamined Japanese Patent Application KOKAI Publication No. 2004-229035 discloses a communication system which allows a player to suspend playing content in the middle of streaming-playing the content, and thereafter allows the same player or any other player to restart playing the following part of the content (so-called resume playing).

Assume that someone wants to suspend playing the content while a given player is streaming-playing the content, and resume playing the following part using any other player. According to the technique disclosed in Unexamined Japanese Patent Application KOKAI Publication No. 2004-229035, in a case where any other player to resume playing the following part is turned off, the user has to turn on this apparatus to make the apparatus Further, if any other player is turned off, the player or the content server cannot easily know the existence of this any other player. Therefore, there is a problem that the range of choice of other players that is allowed to the user to resume playing the content is narrow.

### BRIEF SUMMARY OF THE INVENTION

The present invention was made in view of the above-described problem, and an object of the present invention is to provide a content playing system, a playing apparatus, a streaming play method, and a program suitable for easily resume-playing content streaming-distributed.

To achieve the above object, a content playing system according to a first aspect of the present invention is a content playing system comprising a server which stores content data, and a first playing apparatus and a second playing apparatus which receive and play the content data.

The first playing apparatus comprises: a playing unit, a suspension reception unit, an acquiring unit, and a first sending unit.

The playing unit acquires the content data from the server and plays it.

The suspension reception unit receives an input for instructing suspension of playing of the content data while the content data is played by the playing unit.

The acquiring unit acquires a position from which playing of the content data is resumed, when the suspension reception unit receives the input for instructing suspension.

The first sending unit sends information indicating the position from which playing is resumed, acquired by the acquiring unit, to the second playing apparatus.

The second playing apparatus comprises: a receiving unit, a second sending unit, and a play resuming unit.

The receiving unit receives the information indicating the position from which playing is resumed, sent from the first sending unit.

The second sending unit sends the received information indicating the position from which playing is resumed, to the server.

The play resuming unit acquires data, in the content data, that appears at and after the position from which playing is resumed, from the server, and starts playing the content data from the position from which playing is resumed.

The server comprises a content sending unit which sends the content data to the first playing apparatus or the second playing apparatus.

When the second playing apparatus is to play the content data, the content sending unit sends the content data from the position from which playing is resumed.

Thereby, the content playing system can allow the content to be streaming-played on a playing apparatus from the beginning, or allow playing the content to be easily resumed on a playing apparatus from the position at which playing is suspended.

The first playing apparatus may further comprise a determining unit which determines whether or not the second playing apparatus is in a state capable of playing the content data, and

the first sending unit may send a control signal for requiring the second playing apparatus to become capable of playing the content data to the second playing apparatus in a case where the determining unit determines that the second playing apparatus is not in the state capable of playing the content data, and thereafter send the information indicating the position from which playing is resumed, acquired by the acquiring unit, to the second playing apparatus.

Thereby, the playing apparatuses of the content playing system can control another playing apparatus meant to perform resume playing to become capable of playing the content when it is in a state incapable of playing the content, so that playing the content can be resumed.

The determining unit may determine whether or not the second playing apparatus is turned on, determine that the second playing apparatus is in the state capable of playing the content data in a case where the second playing apparatus is turned on, and otherwise, determine that the second playing apparatus is not in the state capable of playing the content data.

Thereby, the playing apparatuses of the content playing system can control another playing apparatus meant to perform resume playing to be turned on if not turned on, to make it capable of playing, so that resume playing can be performed.

The determining unit may determine whether or not the second playing apparatus is in a state capable of executing a predetermined content playing program, determine that the second playing apparatus is in the state capable of playing the content data in a case where the second playing apparatus is capable of executing the program, and otherwise, determine that the second playing apparatus is not in the state capable of playing the content data.

Thereby, the playing apparatuses of the content playing system can select a playing apparatus to perform resume playing, based o whether or not the playing apparatus can execute the content playing program.

The determining unit may determine whether or not specific application software for performing streaming play is installed on the second playing apparatus, determine that the second playing apparatus is in the state capable of playing the content data in a case where the software is installed on the second playing apparatus, and otherwise, determine that the second playing apparatus is not in the state capable of playing the content data.

The content playing system may further comprise an information processing apparatus comprising:

a storage unit which pre-stores specific application software for playing; and

a communication unit which sends the application software for playing to the first or second playing apparatus, and

in a case where the determining unit determines that the second playing apparatus is not in the state capable of playing the content data, the second playing apparatus may acquire the application software for playing from the information processing apparatus to make itself capable of playing the content data.

The second playing apparatus may further comprise a resumption reception unit which receives an input for instructing start of playing of the content data from the position from which playing is resumed, and

in a case where the resumption reception unit receives an input for instructing start of playing, the play resuming unit may acquire data, in the content data, that appears at and after the position from which playing is resumed, from the server, and start playing the content data from the position from which playing is resumed.

Thereby, the playing apparatuses of the content playing system can start resume playing after an instruction input for starting resume playing is given.

The first playing apparatus may terminate playing at a predetermined timing, which is in a predetermined relation to a timing at which the second playing apparatus starts playing.

A playing apparatus according to a second aspect of the present invention is a playing apparatus for playing content data, and comprises: a playing unit; a suspension reception unit; an acquiring unit; a first sending unit; a second sending unit; and a play resuming unit.

The playing unit acquires the content data from a server, which stores the content data, and plays it.

The suspension reception unit receives an input for instructing suspension of playing of the content data while the content data is played by the playing unit.

The acquiring unit acquires a position from which playing of the content data is resumed, when the suspension reception unit receives the input for instructing suspension.

The first sending unit sends information indicating the position from which playing is resumed, acquired by the acquiring unit, to another playing apparatus different from the playing apparatus.

The receiving unit receives information indicating a position from which playing is resumed, which is sent from another playing apparatus.

The second sending unit sends information indicating a position from which playing is resumed to the server, in a case where the information indicating the position from which playing is resumed, which is sent from another playing apparatus, is received.

The play resuming unit acquires data, in the content data, that appears at and after the position from which playing is resumed, from the server, and starts playing the content data from the position from which playing is resumed.

Thereby, the playing apparatus can easily resume-play the content data, from the position from which playing should be resumed, which is determined based on the position of suspension.

A streaming play method according to a third aspect of the present invention is a streaming play method for playing content data, using a server which stores the content data, and a first playing apparatus and a second playing apparatus which receive and play the content data.

The first playing apparatus comprises a playing step, a suspension reception step, an acquiring step, and a first sending step.

The playing step acquires the content data from the server and plays it.

The suspension reception step receives an input for instructing suspension of playing of the content data while the content data is played.

The acquiring step acquires a position from which playing of the content data is resumed, when the suspension reception step receives the input for instructing suspension.

The first sending step sends information indicating the position from which playing is resumed, acquired by the acquiring step, to the second playing apparatus.

The second playing apparatus comprises:

a receiving step of receiving the information indicating the position from which playing is resumed, sent from the first sending step;

a second sending step of sending the received information indicating the position from which playing is resumed, to the server; and

a play resuming step of acquiring data, in the content data, that appears at and after the position from which playing is resumed from the server, and starting playing the content data from the position from which playing is resumed.

The server, which manages the content data, comprises a content sending step of sending the content data to the first playing apparatus or the second playing apparatus.

In a case where the play resuming step is to play the content data, the content sending step sends the content data from the position from which playing is resumed.

Thereby, a content playing system using this streaming play method can allow the content to be streaming-played on a playing apparatus from the beginning of the content, or playing the content to be easily resumed on a playing apparatus from the position at which playing is suspended.

A streaming play method according to a fourth aspect of the present invention is a streaming play method used by a playing apparatus for playing content data, and comprises a playing step, a suspension reception step, an acquiring step, a first sending step, a receiving step, a second sending step, and a play resuming step.

The playing step acquires the content data from a server, which stores the content data, and plays it.

The suspension reception step receives an input for instructing suspension of playing of the content data while the content data is played.

The acquiring step acquires a position from which playing of the content data is resumed, when the suspension reception step receives the input for instructing suspension.

The first sending step sends information indicating the position from which playing is resumed, acquired by the acquiring step, to another playing apparatus different from the playing apparatus.

The receiving step receives information indicating a position from which playing is resumed, which is sent from another playing apparatus.

The second sending step sends information indicating a position from which playing is resumed to the server, when the information indicating the position from which playing is resumed, which is sent from another playing apparatus, is received.

The play resuming step acquires data, in the content data, that appears at and after the position from which playing is resumed, from the server, and starts playing the content data from the position from which playing is resumed.

Thereby, a playing apparatus using this streaming play method can easily resume-play the content data from the position at which playing of the content data is suspended.

A recording medium according to a fifth aspect of the present invention is a computer-readable recording medium storing a program for controlling a computer used as a playing apparatus for playing content data to function as a playing unit, a suspension reception unit, an acquiring unit, a first sending unit, a receiving unit, a second sending unit, and a play resuming unit.

The playing unit acquires the content data from a server, which stores the content data, and plays it.

The suspension reception unit receives an input for instructing suspension of playing of the content data while the content data is played by the playing unit.

The acquiring unit acquires a position from which playing of the content data is resumed, when the suspension reception unit receives the input for instructing suspension.

The first sending unit sends information indicating the position from which playing is resumed, acquired by the acquiring unit, to another playing apparatus different from the playing apparatus.

The receiving unit receives information indicating a position from which playing is resumed, which is sent from another playing apparatus.

The second sending unit sends information indicating a position from which playing is resumed, to the server, in a case where the information indicating the position from which playing is resumed, which is sent from another playing apparatus, is received.

The play resuming unit acquires data, in the content, that appears at and after the position from which playing is resumed, which position is sent from another playing apparatus, from the server, and starts playing the content data from the position from which playing is resumed.

Thereby, the program can control the computer to function as a playing apparatus which can easily resume-play the content data from the position at which playing of the content data is suspended.

According to the present invention, it is possible to provide a content playing system, a playing apparatus, a streaming play method, and a program suitable for easily resume-playing content streaming-distributed.

### BRIEF DESCRIPTION OF THE DRAWINGS

These objects and other objects and advantages of the present invention will become more apparent upon reading of the following detailed description and the accompanying drawings in which:

FIG. 1 is a diagram showing the structure of a player;

FIG. 2 is a diagram showing the structure of a playing system using the player;

FIG. 3 is a diagram showing the structure of a content server;

FIG. 4 is a flowchart for explaining a playing process;

FIGS. 5A and 5B are diagrams showing examples of screens displayed on a monitor;

FIG. 6 is a diagram for explaining an apparatus switching process;

FIG. 7 is a flowchart for explaining operations of a first player in the apparatus switching process shown in FIG. 6;

FIG. 8 and FIG. 9 are flowcharts for explaining operations of a second player in the apparatus switching process shown in FIG. 6; and

FIG. 10 and FIG. 11 are flowcharts for explaining operations of a content server in the apparatus switching process shown in FIG. 6.

### DETAILED DESCRIPTION OF THE INVENTION

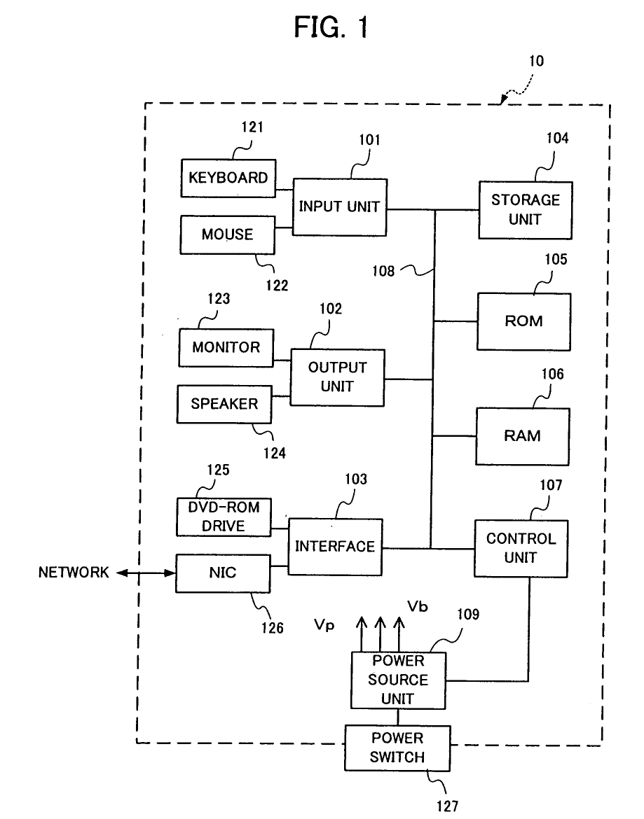

The structure of a player 10 according to an embodiment of the present invention will be explained with reference to FIG. 1. The player 10 comprises an input unit 101, an output unit 102, an interface 103, a storage unit 104, a ROM (Read Only Memory) 105, a RAM (Random Access Memory) 106, a control unit 107, a system bus 108, and a power source unit 109.

The input unit 101 generates an input signal based on an instruction input and a data input entered by the user using a keyboard 121 or a mouse 122, and inputs the signal to the control unit 107. The user can give a desired operation instruction by using the keyboard 121 or the mouse 122. The player 10 may comprise another input device such as a microphone, etc., and an A/D (Analogue to Digital) converter or the like.

The output unit 102 is connected to a monitor 123 for displaying a video, and converts data of a still image, a moving image, or the like into a video signal under the control of the control unit 107 and displays the video on the monitor 123. The output unit 102 is connected to a speaker 124 for outputting a sound, and converts music data, sound data, or the like by means of a D/A (Digital to Analogue) converter (unillustrated) under the control of the control unit 107 and outputs the data by sound. For example, the output unit 102 outputs content streaming-distributed from the Internet, etc. by video and sound under the control of the control unit 107.

The interface 103 is connected to a DVD-ROM (Digital Versatile Disk-Read Only Memory) drive 125, reads out data from a DVD-ROM or a CD-ROM (Compact Disk-Read Only Memory) inserted into the DVD-ROM drive 125, and inputs the read-out data to the control unit 107. The interface 103 is connected to a NIC (Network Interface Card) 126 to connect the player 10 to a network such as a LAN (Local Area Network), etc. and receive or output data from and to the network. The interface 103 may further comprise an interface that can receive and output data from and to other devices with the use of a USB (Universal Serial Bus) or the like. The NIC 126 can connect not only to a LAN, but to other networks such as the Internet, a WAN (Wide Area Network), etc.

The storage unit 104 comprises a storage device such as a hard disk, etc., and stores an operating system (OS), various control programs, etc. which are to be executed by the control unit 107. The storage unit 104 can also store various data including still image data, moving image data, sound data, etc.

The ROM 105 is a non-volatile memory which pre-stores programs, etc. by which the control unit 107 performs predetermined processes. The control unit 107 reads out a program, etc. from the ROM 105 as necessity arises, opens the read-out program, etc. in the RAM 106, and performs a predetermined process based on the program, etc.

The RAM 106 temporarily stores data and programs, and temporarily retains data, etc. read out from the DVD-ROM drive 125. The control unit 107 performs such processes as declaring a variable area in the RAM 106 to perform calculations on the value stored in the variable, or once storing the value stored in the RAM 106 in a register, performing calculations toward the register, and writing back the calculation result in the memory.

The control unit 107 comprises a CPU (Central Processing Unit), etc., controls the entire operation of the player 10, and is connected to each structural element described above to exchange control signals and data. By using an ALU (Arithmetic Logic Unit) (unillustrated), the CPU 107 can perform arithmetic operations such as addition, subtraction, multiplication, division, etc., logical operations such as logical addition, logical multiplication, logical negation, etc., bit operations such as bit addition, bit multiplication, bit inversion, bit shift, bit rotation, etc. toward a storage area, or a register (unillustrated), which can be accessed at a high speed. Further, the CPU 107 itself may be designed to be able to rapidly perform saturate calculations such as addition, subtraction, multiplication, division, etc. for dealing with multimedia processes, trigonometric function or vector operations, etc. or may realize these with a coprocessor.

The system bus 108 is a transmission path through which commands and data are transmitted among the input unit 101, the output unit 102, the interface 103, the storage unit 104, the ROM 105, the RAM 106, and the control unit 107.

The power source unit 109 comprises a power switch 127 by which the player 10 is turned on or off, in response to a user operation. The power source unit 109 is connected to the control unit 107. When the player 10 is turned off (i.e., in a standby state), the power source unit 109 supplies power to the control unit 107 and the interface 103 from a standby power source (Vb). When the player 10 is turned on, the power source unit 109 starts supplying power to each structural element of the player 10 from a power source (Vp).

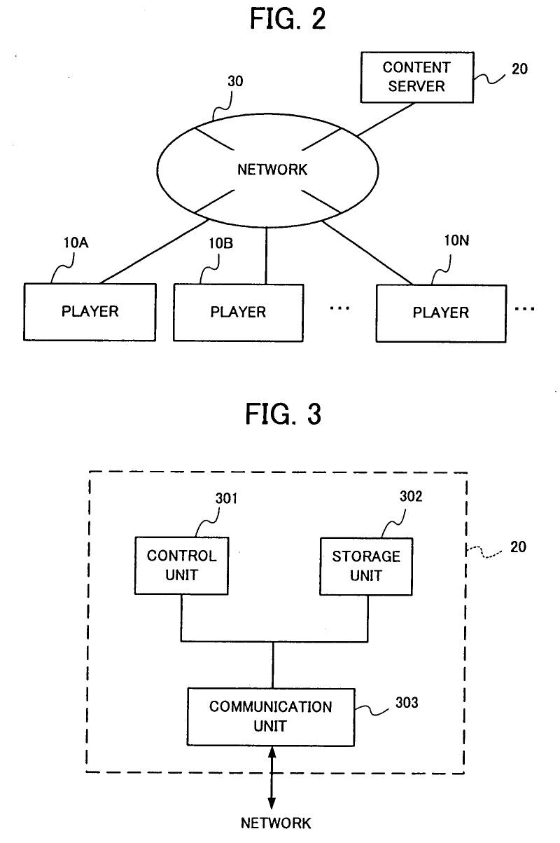

Next, the structure of the entire content playing system, in which the player 10 performs streaming play, will be explained with reference to FIG. 2.

The playing system comprises a plurality of players 10 (denoted as 10A, 10B, 10N, etc. in the drawing), a content server 20, and a network 30. The player 10 acquires content data such as moving image data from the content server 20 to which it is connected via the network 30, simultaneously with playing the data (i.e., streaming-plays the data). The number of players 10 connected to the network 30 is no object. The content server 20 stores various content data including moving image data such as movies, etc. and sound data such as music, etc., in addition to still image data and text data. On receiving a request demanding distribution of content data from a player 10 or any other information processing apparatus connected to the network 30, the content server 20 sends corresponding content data to, for example, the player 10, which has made that request. In the present embodiment, there is one content server 20, but may be a plurality of content servers. The network 30 is typically a LAN, but may be any other network such as the Internet, a WAN, etc.

FIG. 3 is a diagram showing the structure of the content server 20. The content server 20 comprises a control unit 301, a storage unit 302, and a communication unit 303.

The control unit 301 comprises a CPU and a storage device (RAM or the like) to serve as a work area, and controls each unit of the content server 20 according to an OS, programs, etc. stored in the storage unit 302. For example, the control unit 301 performs control of acquiring content data stored in the storage unit 302 and sending it to the player 10. The details will be described later.

The storage unit 302 comprises a suitable storage device such as a hard disk drive, a ROM, etc. The storage unit 302 stores the OS and programs for controlling the entire content server 20, and programs and data, etc. for providing predetermined content to a user. For example, the storage unit 302 stores various content data including moving image data such as movies, etc., and sound data such as music, etc. The storage unit 302 stores these content data in, typically but not limited to, a hard disk device. For example, the content data may be stored in any computer-readable information recording medium such as a digital video disk, a compact disk, a flexible disk, a magneto-optical disk, a semiconductor memory, etc. In this case, the content server 20 needs to comprise a device such as a DVD-ROM drive, a memory card reader, etc., that can read out data stored in these recording media.

The communication unit 303 comprises a relevant communication device such as a NIC, a router, a modem, etc. For example, the communication unit 303 receives a request demanding sending of data, etc. relating to designated content from the player 10, and sends corresponding content data, etc., based on an instruction from the control unit 301.

The content server 20 having the above-described structure receives a request demanding streaming play of the content from the player 10, and distributes content data so that the player 10 can streaming-play the content. The content server 20 receives a request demanding suspension of streaming play and demanding resume playing from an arbitrary playing position, and controls distribution of the content data so that the streaming play will start from the designated playing position.

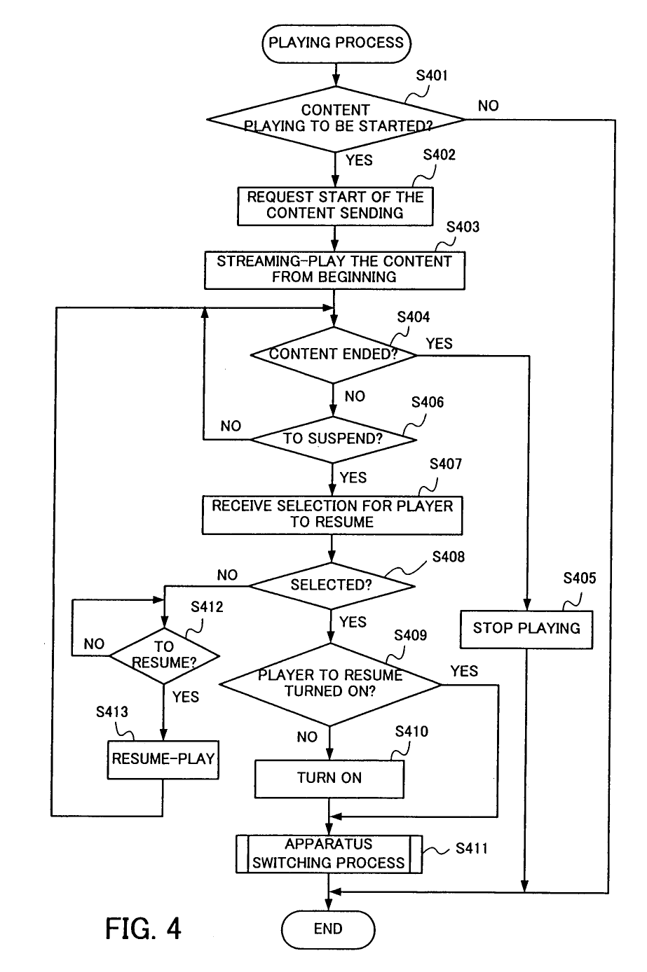

Next, a process (hereinafter referred to as “playing process”) by the player 10 to streaming-play content data stored in the content server 20 will be explained with reference to a flowchart of FIG. 4. This playing process is a process performed by the control unit 107, etc. of the player 10. In the present embodiment, explanation will be given in an example where a user suspends playing of content streaming-played by a given player 10A in the middle of the playing, and resumes the playing from where the playing is suspended, by another player 10B (resume-plays the content).

The position to resume the playing may be the position at which the playing is suspended, or a position determined by a predetermined method from the position of suspension. A position determined by a predetermined method from the position of suspension is such a position in the content as follows. For example, in a case where sound data is streaming-played, the position of resumption may be the last silent part that appears ahead of the position of suspension and continues for a predetermined time or longer. Alternatively, the position of resumption may be the position reached by returning from the position of suspension by a predetermined time. In a case where a moving image is streaming-played and suspension is instructed while a given frame is being played, the head of the frame may be the position of resumption. In a case where, for example, moving image data includes any reference image frame followed by few frames which are represented by data showing difference from preceding frames, the position of resumption may be determined retroactively at the reference image. Alternatively, the position of resumption may be an arbitrary position designated by the user. In the case of a video game or the like, the position of resumption may be immediately behind a data position at which the user has made any game operation and which is immediately ahead of the position of suspension.

The control unit 107 calculates these positions of resumption. For example, in the case of the last silent part, the control unit 107 monitors the level of the sound played, and updates the record of the position where a sound equal to or smaller than a threshold continues for a predetermined time to determine the position of the silent part that is stored when the data is suspended, as the position of resumption. Hereinafter, “the position of resumption” refers to the position of suspension or a position determined by a predetermined method in relation to the position of suspension as described above.

Hereinafter, to indicate any component of a player 10A, “A” will be added to the tail of the reference numeral of the component (e.g., control unit 107A), and to indicate any component of a player 10B, “B” will be added to the tail of the reference numeral of the component (e.g., control unit 107B).

First, the control unit 107A of the player 10A determines whether or not content playing is to be started (step S401). For example, the control unit 107A controls the output unit 102A to display a content playing screen on the monitor 123A, controls the input unit 101A to receive any instruction to start content playing, and determines whether or not it has received any instruction signal to start content playing. The user can give an instruction to start content playing, an instruction to terminate content playing, an instruction to resume-play the content, etc., by operating the keyboard 121A or the mouse 122A.

In a case where it is determined that content playing is not to be started (step S401, NO), the control unit 107A terminates the playing process.

In a case where it is determined that content playing is to be started (step S401, YES), the control unit 107A controls the interface 103A to request the content server 20 to send content data (step S402). At this time, the control unit 107A gives control such that playing is started from the beginning of the content.

The control unit 107A starts streaming-playing the content from its beginning (step S403).

Next, the control unit 107A determines whether or not the content being played has come to an end (step S404).

In a case where it is determined that the content has come to an end (step S404, YES), the control unit 107A quits streaming play (step S405), and terminates the playing process.

In a case where it is determined that the content has not come to an end (step S404, NO), the control unit 107A determines whether or not streaming play is to be suspended (step S406). The control unit 107A determines whether or not playing the content is to be resumed by takeover, after it is suspended.

In a case where it is determined that playing the content is not to be suspended (resumed) (step S406, NO), the control unit 107A returns to step S404. That is, the control unit 107A continues playing the content data.

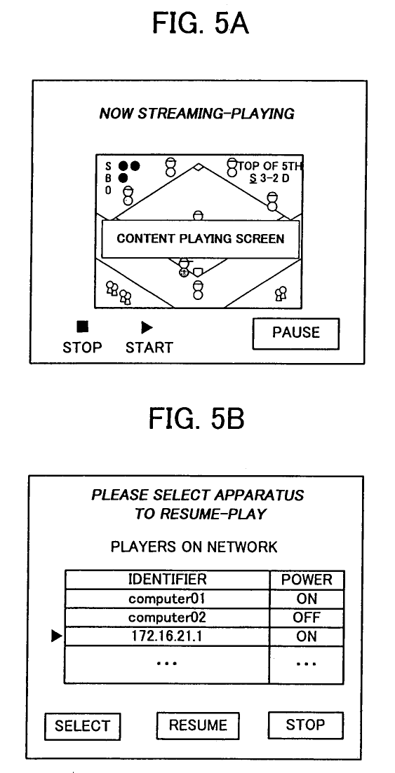

The act of suspending playing by the player 10A, which is now streaming-playing the content, and resuming playing of the same content by another player 10B from a position of resumption determined based on the position of suspension is named resume playing by takeover. That is, at this step, it is determined whether or not the content viewing on the player 10A now streaming-playing the content is to be suspended, and whether or not playing the content is to be resumed on another player 10B from any position of resumption. For example, the control unit 107A controls the output unit 102A to display a screen as shown in FIG. 5A on the monitor 123A and wait for any selection instruction to be input by the user, and determines that the user is to suspend (then resume-play) the content if a pause button is depressed.

In a case where it is determined that playing the content is to be suspended (resumed) (step S406, YES), the control unit 107A receives a selection for another player 10 that is to resume playing (step S407). For example, the control unit 107A controls the output unit 102A to display a screen as shown in FIG. 5B on the monitor 123A to receive a selection instruction from the user. In the drawing, the control unit 107A displays a list of other players connected to the network 30, and the state of the power source of each of these playing apparatuses. Further, the control unit 107A determines the position to resume playing.

Here, if the network 30 is in the Internet environment or an intranet environment, the list of players 10 may be a list of such players 10 as existing in the domain to which the player 10A belongs. For example, a list of players 10 that are in the same segment of the network 30 as the player 10A used in the current streaming play may be used. The players 10 can be identified with the use of identification information such as computer name, IP address, MAC address, etc. It is possible to discriminate the power source state of the players 10 by sending a predetermined response requiring signal to the players 10 and determining whether or not a response to that signal is returned.

Next, the control unit 107A determines whether or not a player 10 that is to perform resume playing has been selected (step S408).

In a case where it is determined that no player 10 to perform resume playing has been selected (step S408, NO), the control unit 107A waits until resumption of playing is instructed (step S412, NO). When resumption of playing is input (step S412, YES), the control unit 107A resumes playing from the position of resumption (step S413). Then, the control unit 107A returns to step 404.

In a case where it is determined that no player 10 to perform resume playing has been designated, the control unit 107A may terminate the playing process. In this case, for example, the control unit 107A displays a screen as shown in FIG. 5B. When no selection for a player 10 to perform resume playing is received but an instruction input for terminating playing is received, the control unit 107A stops playing and terminates the playing process. Alternatively, in a case where no instruction input is received before a predetermined time-out period passes after the control unit 107A, for example, displays this selection screen to become open to receive an instruction input for a player 10 to perform resume playing from the user, the control unit 107A may return to the previous content playing screen or stop playing to terminate the playing process.

In a case where it is determined that any player 10 to perform resume playing is selected (step S408, YES), the control unit 107A determines whether or not the selected player 10 is in a power on state (a state that the power source is turned on and playing is executable) (step S409). Here, it is assumed that the player 10B is selected.

In a case where the selected player 10B is in a power off state (step S409, NO), the control unit 107A remotely turns on the power of the designated player (step S410), and performs an apparatus switching process to be described later (step S411). For example, the control unit 107A turns on the power of that apparatus by using a WOL (Wake On LAN) function used in general.

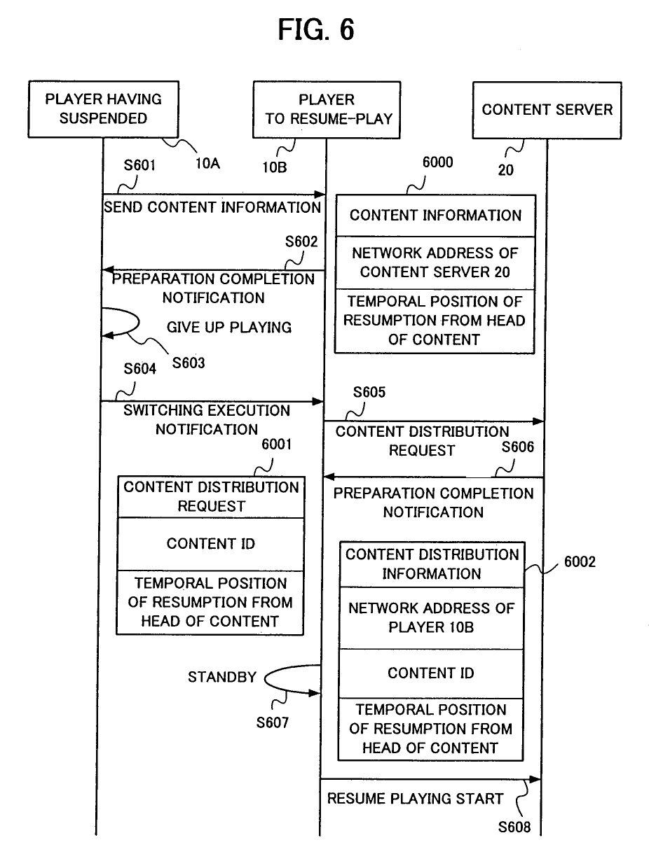

In a case where the selected player 10B is in the power on state (step S409, YES), the control unit 107A performs an apparatus switching process as shown in FIG. 6 (step S411). That is, the control unit 107A switches streaming play from the player 10A that has suspended it to the player 10B designated, and starts resume playing on the player 10B.

Specifically, in the apparatus switching process, the control unit 107A of the player 10A that has suspended streaming play controls the interface 103A to send content information 6000 about the content, which is now played, to the player 10B which is to resume-play the content (step S601). This content information includes information for specifying the content server 20 that distributes the content now played (this information may be the network address, port number, etc. of the server), and information indicating the position in the content at which streaming play should be resumed. This position, from which the streaming play should be resumed, is represented by, for example, an address indicating the position in the content data to be streaming-played, a temporal position from the head of the content, etc. In the present embodiment, the content information 6000 comprises the network address of the content server 20 and the temporal position of the position of resumption from the head of the content.

The control unit 107B of the player 10B to perform resume playing activates application software used for streaming play to be prepared for streaming play. When it has become prepared, the control unit 107B of the player 10B controls the interface 103B to send a notification to the player 10A that it has got prepared (step S602).

The control unit 107A of the player 10A that has suspended streaming play gives up streaming play (step S603).

Then, the control unit 107A of the player 10A that has stopped streaming play controls the interface 103A to notify the player 10B that is to perform resume playing, that switching of apparatuses that is to perform playing should be executed (step S604).

When the control unit 107B of the player 10B that is to perform resume playing controls the interface 103B and receives the notification of switching of apparatuses to perform playing (notification of resume playing execution), the control unit 107B sends a content distribution request 6001 demanding distribution of the content to be resumed to the content server 20 (step S605). Here, the control unit 107B of the player 10B sends information on the content to be resumed, to the content server 20. This information includes information (content name or the like) for identifying the content to be resume-played, and the position to resume playing. In the present embodiment, the distribution request 6001 comprises a content ID and the temporal position of the position of resumption from the head of the content.

The control unit 301 of the content server 20 prepares for distributing the content data corresponding to the content to be resume-played, from the position to resume playing. This preparation includes storing, in addition to the content distribution request 6001 sent from the player 10B, information for specifying the sender of this content distribution request 6001, as content distribution information 6002. In the present embodiment, the content distribution information 6002 comprises the content ID, the temporal position of the position of resumption from the head of the content, and the network address of the player 10B to perform resume playing. When the preparation is completed, the control unit 301 of the content server 20 notifies this to the player 10B (step S606).

The control unit 107B of the player 10B to perform resume playing receives the notification of preparation completion from the content server 20 and becomes on standby for the start of resume playing (step S607). That is, the player 10B does not immediately start resume playing, but waits until the user gives an instruction input for starting resume playing.

Then, on receiving an instruction input for starting resume playing from the user, the control unit 107B of the player 10B resumes streaming play (step S608). At this time, the control unit 301 of the content server 20 sends the content data to the player 10B from the data position in the content data to be streaming-played, that corresponds to the position of resumption that has been received at step S605 from the player 10B.

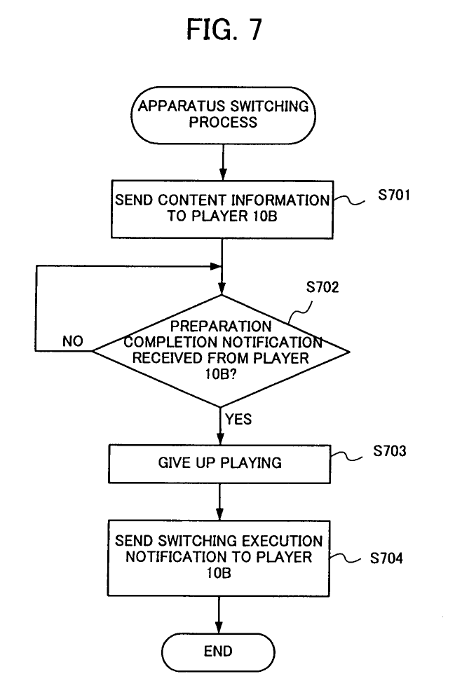

Next, detailed operations of each of the players 10A and 10B and the content server 20 in the apparatus switching process (step S411) of FIG. 4 will be explained with reference to FIG. 7 to FIG. 11. The steps of FIG. 6 will timely be mentioned.

The flowchart of FIG. 7 explains the operations of the player 10A. When the apparatus switching process is started, first, the control unit 107A of the player 10A sends content information to the player 10B (step S701). This step corresponds to step S601 of FIG. 6 explained above.

After this, the control unit 107A of the player 10A determines whether or not it has received a preparation completion notification from the player 10B (step S702). In a case where it is determined that it has been received (step S702, YES), the control unit 107A gives up playing of the content (step S703). This step corresponds to step S603 of FIG. 6. In a case where it is determined that none has been received (step S702, NO), the control unit 107A enters a waiting state.

After content playing is given up at step S703, the control unit 107A of the player 10A sends a switching execution notification to the player 10B (step S704). This step corresponds to step S604 of FIG. 6. After this, the process of the player 10A is terminated.

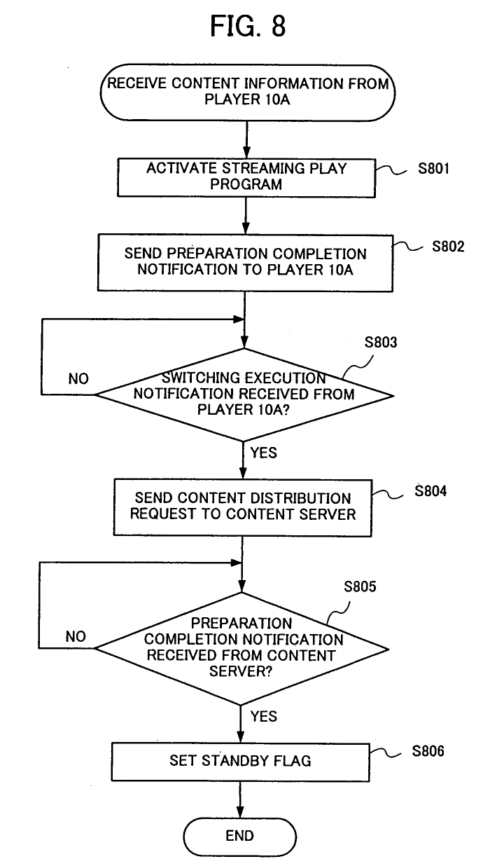

With reference to FIG. 8, the operations of the player 10B to perform resume playing, after the player 10B receives the content information from the player 10A, will be explained. As described above, the content information includes information (network address, port number, etc. of the server) for specifying the content server 20 to distribute the content now played, and the position in the content to resume streaming play from.

First, the control unit 107B of the player 10B activates application software used for streaming play, to be prepared for streaming play (step S801). When it has got prepared, the control unit 107B controls the interface 103B to send a notification to that effect to the player 10A (step S802). This step corresponds to step S602 of FIG. 6.

After this, the control unit 107B of the player 10B determines whether or not it has received a switching execution notification from the player 10A (step S803). In a case where it is determined that it has been received (step S803, YES), the control unit 107B sends a distribution request to the content server 20 (step S804). This step corresponds to step S605 of FIG. 6. In a case where it is determined that none has been received (step S803, NO), the control unit 107B enters a waiting state.

After sending the distribution request to the content server 20, the control unit 107B of the player 10B determines whether or not it has received a preparation completion notification from the content server 20 (step S805). In a case where it is determined that it has been received (step S805, YES), the control unit 107B of the player 10B sets a standby flag indicating that it has received a preparation completion notification from the content server 20 (step S806), whereby the process is completed. Here, the player 10B enters the standby state indicated at step S607 of FIG. 6.

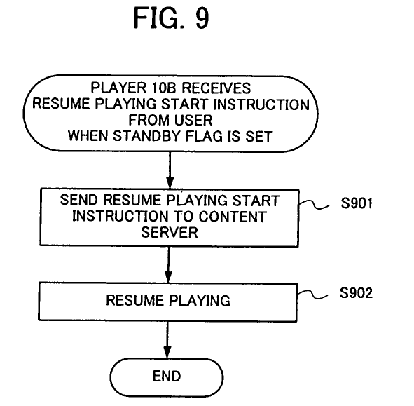

Next, the operations of the player 10B when an instruction input for starting resume playing is given by the user while the player 10B is in the standby state mentioned above (i.e., when the standby flag is set), will be explained with reference to FIG. 9.

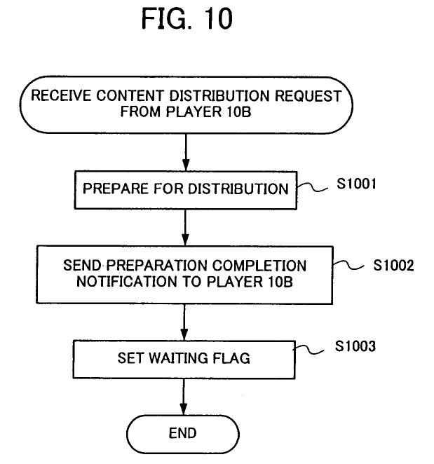

On receiving an instruction for starting resume playing from the user, the control unit 107B of the player 10B sends a resume playing start instruction to the content server 20 (step S901). After this, the control unit 107B receives distribution from the content server 20 (step S1004 of FIG. 10, to be described later in detail), and resumes playing (step S902).

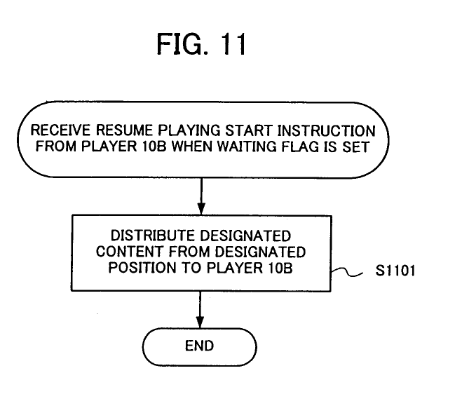

Next, the operations of the content server 20 in the apparatus switching process will be explained with reference to FIG. 10 and FIG. 11.

After the control unit 30 of the content server 20 receives the content distribution request from the player 10B (step S605 of FIG. 6), it prepares for distributing content data corresponding to the content to be resume-played to the player 10B, from the position to resume streaming play (step S1001). When the preparation is completed, the control unit 301 gives a notification to that effect to the player 10B (step S1002). This step corresponds to step S606 of FIG. 6. After this, the content server 20 sets a waiting flag (step S1003) and terminates the process.

Next, in a case where the content server 20 receives a resume playing start instruction from the player 10B while the waiting flag is set, the control unit 301 of the content server 20 distributes, via the communication unit 303, the designated content to the player 10B from the position of resumption designated, as shown in FIG. 11 (step S1101).

As described above, according to the present embodiment, on receiving an instruction for resume playing by takeover from the user, the player 10A can control another arbitrary player 10B selected by the user to take over the playing from the position of suspension or the position of resumption. Further, even if another player 10 is turned off, it is possible to turn on this player 10 to perform resume playing.

Resume playing by takeover enables, in turn, the player 10B, which has started streaming play of the content, to have yet another player 10 perform resume playing by takeover. The player 10B, which performs streaming play by resume playing by takeover, corresponds to the state of step S404 or step S406 of FIG. 4. Regardless of whether the triggering factor of starting streaming play of the content is an instruction input for starting content playing from the user or resume playing by takeover, the player 10 that is performing streaming play can perform the process of resume playing by takeover.

Further, whatever the triggering factor of starting streaming play is, the player 10 can exert resume playing by takeover, while it performs streaming play. The triggering factors of starting streaming play include, for example, the player 10 being activated by schedule and timer to start streaming play, an instruction from the content server 20, etc. to start streaming play, etc. In these cases, it is possible to consider that an input for instructing start of content data playing is given from the timer or the content server, 20, etc.

The present invention is not limited to the above-described embodiment, but can be modified and applied in various manners.

As a modified example, at step S407, the control unit 107 may receive an instruction input for the position to resume playing from the user and control streaming play to be resumed from the position indicated by this instruction input. In this case, the control unit 107A of the player 10A may send an address, a pointer, a temporal position, or the like that indicates the designated position of resumption to the content server 20, and the control unit 301 of the content server 20 may start sending the content data from the position of resumption received. With this scheme, the content playing system can resume playing from the playing position desired by the user of the player 10A.

Further, at step S402, the control unit 107 may receive an instruction input for the position to start playing from the user, and start streaming play from the position indicated by this instruction input. The control unit 107A of the player 10A may send an address, a pointer, a temporal position, or the like that indicates the position to start playing of the content data to the content server 20, and the control unit 301 of the content server 20 may start sending the content data from the position to start playing received.

As another modified example, at step S408, the control unit 107A of the player 10A may determine whether or not the player 10B meant to resume-play the content data now streaming-played is in a state capable of playing.

For example, the control unit 107A of the player 10A may determine whether or not application software for performing streaming play is installed on the player 10B meant to perform resume playing.

In this case, the control unit 107A of the player 10A controls the interface 103A to send a signal that requests a response indicating whether or not appropriate application software for playing is installed on the player 10B and usable, to the player 10B. On receiving this signal, the control unit 107B of the player 10B determines whether or not the appropriate application software is installed and usable, and sends the determination result to the player 10A.

The control unit 107A of the player 10A performs the above-described apparatus switching process, in a case where the appropriate application software is installed on the player 10B. To the contrary, in a case where the software is not installed, the control unit 107A terminates the apparatus switching process without exerting resume playing by takeover.

With this scheme, the content playing system can control any player 10 that has the appropriate application software for playing installed, to perform resume playing.

Further, at step S409, the control unit 107A of the player 10A may determine, in addition to whether or not the player 10B is turned on, whether or not certain application software for streaming play is installed.

Further, as another modified example, at step S408, the control unit 107A of the player 10A may determine whether or not certain application software for streaming play is installed on the player 10B meant to perform resume playing, and install the application software on the player 10B if not installed, to make the player 10B capable of resume playing.

The control unit 107A of the player 10A controls the interface 103A to send a signal that requires a response indicating whether or not the specific application software for playing is installed on the player 10B and usable, to the player 10B. On receiving this signal, the control unit 107B of the player 10B determines whether or not the application software for playing is installed and usable, and sends the determination result to the player 10A.

The control unit 107A of the player 10A performs the above-described apparatus switching process in a case where the specific application software is installed on the player 10B. To the contrary, in a case where not installed, the control unit 107A starts the above-described apparatus switching process, after controlling the player 10B to acquire the application software for playing from another information processing apparatus that pre-stores the specific application software for playing to make the player 10B capable of streaming play. In this case, the content server 20 may function as this information processing apparatus.

The above-described embodiment explains that the control unit 107A of the player 10A suspends playing before step S407, and gives up streaming play at step S603. However, the timing to suspend or give up playing is not limited to this. For example, the player 10A may stop streaming play after the player 10B, which is to successively play the content by resume playing by takeover, starts playing at step S608. Needless to say, such a modified example is also included in the scope of the present invention.

As the content server 20, for example, a personal computer, a data server, a DVD player, a DVD recorder, a CD player, a hard disk recorder, etc. can be used.

As explained above, according to the present invention, it is possible to provide a content playing system, a player, a streaming play method, and a program suitable for easily resume-playing content streaming-distributed.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. A content playing system comprising a server which stores content data, and a first playing apparatus and a second playing apparatus which receive and play the content data,
wherein said first playing apparatus comprises:
a playing unit which acquires the content data from said server and plays it;
a suspension reception unit which receives an input for instructing suspension of playing of the content data while the content data is played by said playing unit;
an acquiring unit which acquires a position from which playing of the content data is resumed, when said suspension reception unit receives the input for instructing suspension; and
a first sending unit which sends information indicating the position from which playing is resumed, acquired by said acquiring unit, to said second playing apparatus,
said second playing apparatus comprises:
a receiving unit which receives the information indicating the position from which playing is resumed, sent from said first sending unit;
a second sending unit which sends the received information indicating the position from which playing is resumed, to said server; and
a play resuming unit which acquires data, in the content data, that appears at and after the position from which playing is resumed, from said server, and starts playing the content data from the position from which playing is resumed,
said server comprises a content sending unit which sends the content data to said first playing apparatus or said second playing apparatus, and
when said second playing apparatus is to play the content data, said content sending unit sends the content data from the position from which playing is resumed.

2. The content playing system according to claim 1,
wherein said first playing apparatus further comprises a determining unit which determines whether or not said second playing apparatus is in a state capable of playing the content data, and
said first sending unit sends a control signal for requiring said second playing apparatus to become capable of playing the content data to said second playing apparatus in a case where said determining unit determines that said second playing apparatus is not in the state capable of playing the content data, and thereafter sends the information indicating the position from which playing is resumed, acquired by said acquiring unit, to said second playing apparatus.

3. The content playing system according to claim 2,
wherein said determining unit determines whether or not said second playing apparatus is turned on, determines that said second playing apparatus is in the state capable of playing the content data in a case where said second playing apparatus is turned on, and otherwise, determines that said second playing apparatus is not in the state capable of playing the content data.

4. The content playing system according to claim 2,
wherein said determining unit determines whether or not said second playing apparatus is in a state capable of executing a predetermined content playing program, determines that said second playing apparatus is in the state capable of playing the content data in a case where said second playing apparatus is capable of executing the program, and otherwise, determines that said second playing apparatus is not in the state capable of playing the content data.

5. The content playing system according to claim 2,
wherein said determining unit determines whether or not specific application software for performing streaming play is installed on said second playing apparatus, determines that said second playing apparatus is in the state capable of playing the content data in a case where the software is installed on said second playing apparatus, and otherwise, determines that said second playing apparatus is not in the state capable of playing the content data.

6. The content playing system according to claim 2, further comprising
an information processing apparatus comprising:
a storage unit which pre-stores specific application software for playing; and
a communication unit which sends the application software for playing to said first or second playing apparatus,
wherein in a case where said determining unit determines that said second playing apparatus is not in the state capable of playing the content data, said second playing apparatus acquires the application software for playing from said information processing apparatus to make itself capable of playing the content data.

7. The content playing system according to claim 1,
wherein said second playing apparatus further comprises a resumption reception unit which receives an input for instructing start of playing of the content data from the position from which playing is resumed, and
in a case where said resumption reception unit receives an input for instructing start of playing, said play resuming unit acquires data, in the content data, that appears at and after the position from which playing is resumed, from said server, and starts playing the content data from the position from which playing is resumed.

8. The content playing system according to claim 2,
wherein said second playing apparatus further comprises a resumption reception unit which receives an input for instructing start of playing of the content data from the position from which playing is resumed, and
in a case where said resumption reception unit receives an input for instructing start of playing, said play resuming unit acquires data, in the content data, that appears at and after the position from which playing is resumed, from said server, and starts playing the content data from the position from which playing is resumed.

9. The content playing system according to claim 3,
wherein said second playing apparatus further comprises a resumption reception unit which receives an input for instructing start of playing of the content data from the position from which playing is resumed, and
in a case where said resumption reception unit receives an input for instructing start of playing, said play resuming unit acquires data, in the content data, that appears at and after the position from which playing is resumed, from said server, and starts playing the content data from the position from which playing is resumed.

10. The content playing system according to claim 4,
wherein said second playing apparatus further comprises a resumption reception unit which receives an input for instructing start of playing of the content data from the position from which playing is resumed, and
in a case where said resumption reception unit receives an input for instructing start of playing, said play resuming unit acquires data, in the content data, that appears at and after the position from which playing is resumed, from said server, and starts playing the content data from the position from which playing is resumed.

11. The content playing system according to claim 7,
wherein said first playing apparatus terminates playing at a predetermined timing, which is in a predetermined relation to a timing at which said second playing apparatus starts playing.

12. A playing apparatus for playing content data, comprising:
a playing unit which acquires the content data from a server, which stores the content data, and plays it;
a suspension reception unit which receives an input for instructing suspension of playing of the content data while the content data is played by said playing unit;
an acquiring unit which acquires a position from which playing of the content data is resumed, when said suspension reception unit receives the input for instructing suspension;
a first sending unit which sends information indicating the position from which playing is resumed, acquired by said acquiring unit, to another playing apparatus different from said playing apparatus;
a receiving unit which receives information indicating a position from which playing is resumed, which is sent from another playing apparatus;
a second sending unit which sends information indicating a position from which playing is resumed to said server, in a case where the information indicating the position from which playing is resumed, which is sent from another playing apparatus, is received; and
a play resuming unit which acquires data, in the content data, that appears at and after the position from which playing is resumed, from said server, and starts playing the content data from the position from which playing is resumed.

13. A streaming play method for playing content data, using a server which stores the content data, and a first playing apparatus and a second playing apparatus which receive and play the content data, said method comprising:
a playing step at which said first playing apparatus acquires the content data from said server and plays it;
a suspension reception step at which said first playing apparatus receives an input for instructing suspension of playing of the content data while the content data is played;
an acquiring step at which said first playing apparatus acquires a position from which playing of the content data is resumed, when said suspension reception step receives the input for instructing suspension;
a first sending step at which said first playing apparatus sends information indicating the position from which playing is resumed, acquired by said acquiring step, to said second playing apparatus;
a receiving step at which said second playing apparatus receives the information indicating the position from which playing is resumed, sent from said first sending step;
a second sending step at which said second playing apparatus sends the received information indicating the position from which playing is resumed, to said server;
a play resuming step at which said second playing apparatus acquires data, in the content data, that appears at and after the position from which playing is resumed from said server, and starts playing the content data from the position from which playing is resumed; and
a content sending step at which said server sends the content data to said first playing apparatus or said second playing apparatus,
wherein in a case where said play resuming step is to play the content data, said content sending step sends the content data from the position from which playing is resumed.

14. A streaming play method used by a playing apparatus for playing content data, comprising:
a playing step of acquiring the content data from a server, which stores the content data, and playing it;
a suspension reception step of receiving an input for instructing suspension of playing of the content data while the content data is played;
an acquiring step of acquiring a position from which playing of the content data is resumed, when said suspension reception step receives the input for instructing suspension;
a first sending step of sending information indicating the position from which playing is resumed, acquired by said acquiring step, to another playing apparatus different from said playing apparatus;
a receiving step of receiving information indicating a position from which playing is resumed, which is sent from another playing apparatus;
a second sending step of sending information indicating a position from which playing is resumed to said server, when the information indicating the position from which playing is resumed, which is sent from another playing apparatus, is received; and
a play resuming step of acquiring data, in the content data, that appears at and after the position from which playing is resumed, from said server, and starting playing the content data from the position from which playing is resumed.

15. A computer-readable recording medium storing a program for controlling a computer used as a playing apparatus for playing content data to function as:
a playing unit which acquires the content data from a server, which stores the content data, and plays it;
a suspension reception unit which receives an input for instructing suspension of playing of the content data while the content data is played by said playing unit;
an acquiring unit which acquires a position from which playing of the content data is resumed, when said suspension reception unit receives the input for instructing suspension;
a first sending unit which sends information indicating the position from which playing is resumed, acquired by said acquiring unit, to another playing apparatus different from said playing apparatus;
a receiving unit which receives information indicating a position from which playing is resumed, which is sent from another playing apparatus;
a second sending unit which sends information indicating a position from which playing is resumed, to said server, in a case where the information indicating the position from which playing is resumed, which is sent from another playing apparatus, is received; and
a play resuming unit which acquires data, in the content, that appears at and after the position from which playing is resumed, which position is sent from another playing apparatus, from said server, and starts playing the content data from the position from which playing is resumed.
